(19) United States
(12) Patent Application Publication
(10) Pub. No.: US 2014/0310868 A1
(43) Pub. Date: Oct. 23, 2014

(54) BATH LIFT ASSEMBLY

(71) Applicant: Care-Knight Limited, Stoke-onTrent, Staffordshire (GB)

(72) Inventor: William Lee Steadman, Stoke-on-Trent (GB)

(21) Appl. No.: 14/361,977

(22) PCT Filed: Dec. 3, 2012
(86) PCT No.: PCT/GB2012/052984

§ 371 Date: May 30, 2014

(30) Foreign Application Priority Data
Dec. 6, 2011 (GB) 1120944.2
Dec. 16, 2011 (GB) 1121702.3

(51) Int. Cl. A61G 7/10

(52) U.S. Cl. CPC A61G 7/1003
USPC 4/565.1

(57) ABSTRACT

A bath lift assembly 10 with a U shaped frame 14 which locates on top of the end of a bar. A drive arrangement 20 is provided on each corner of the frame 14, which drive arrangements 20 respectively wind or unwind a band 32 extending between the side limbs of the frame 14, upon which band 32 a person can sit to be lowered into a bath and raised back out thereof.

This invention concerns a bath lift assembly.

Bath lifts are used by a wide range of persons, and particularly the elderly and others with limited mobility. They enable a person to bathe in a conventional bath in a safe manner, and without the requirement for outside assistance. Conventionally bath lifts require at least semi permanent mounting in a bathroom, and hence are in situ even when persons are using the bath who do not require to use a bath lift. This also means that if a person requires to use a bath lift, they must have a lift installed in each bath they wish to use.

According to the present invention there is provided a bath lift assembly, the assembly including an at least generally U-shaped frame selectively mountable on top of the end of a bath to extend across the end of the bath and part way along the sides of the bath leading therefrom, a roller assembly being provided on each side of the frame with a flexible band upon which a person can sit extending between the assemblies on each side, a drive system being provided to simultaneously operate each roller assembly to selectively feed the band in or out, such that the band is moveable between a raised position with the band taut across the top of the bath, and a lowered position with the band substantially resting on the bottom of the bath.

In one embodiment the drive system comprises a single drive arrangement which operates each roller assembly, and the drive arrangement may be connected to each roller assembly by a respective drive chain.

In a further embodiment, the drive system comprises a separate drive arrangement for each side of the assembly.

The drive arrangement or arrangements may be arranged to automatically stop when one of the raised or lowered positions is reached. An adjustable stop arrangement may be provided to cause the automatic stopping when the raised or lowered positions are reached.

The apparatus may be battery powered, and the batteries may be rechargeable.

Alternatively the apparatus may be mains powered via a transformer.

A hand-held controller may be provided for a user to operate the assembly.

Alternatively or in addition, switches may be provided on the assembly to operate the assembly.

Mounting brackets may be provided on the underside of the frame engageable with the bath to retain the assembly in position. At least some of the mounting brackets may be substantially L-shaped. At least some of the mounting brackets may be substantially n-shaped. The mounting brackets may be adjustably mounted on the underside of the frame to be engageable with different sized baths.

A mounting member may be provided on at least one side of the assembly, engageable with a wall mountable bracket, to retain a side of the assembly substantially against the wall.

The length of the base of the U of the frame may be adjustable to permit use with different width baths.

Embodiments of the present invention will now be described by way of example only and with reference to the accompanying drawings, in which:—

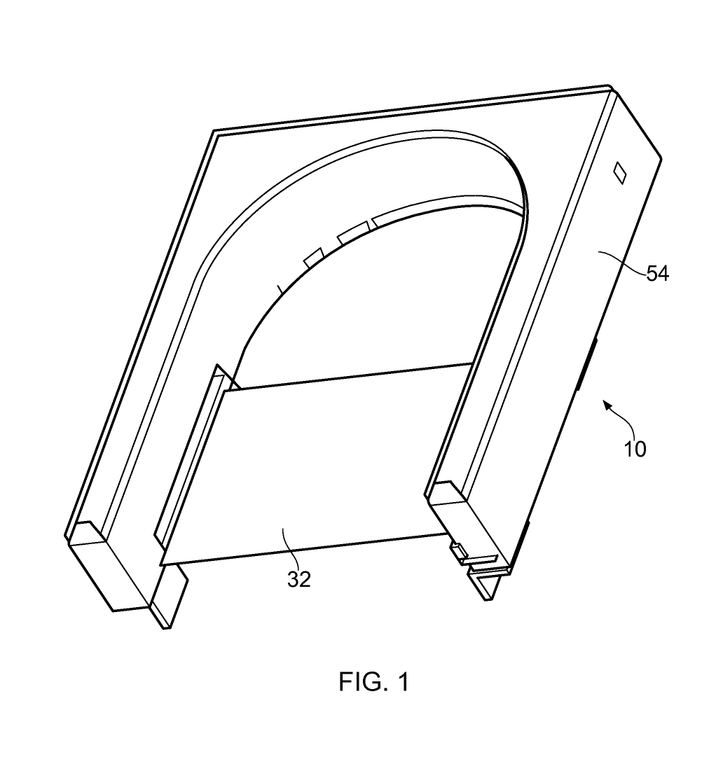

FIG. 1 is a diagrammatic perspective view from above of a first bath lift assembly according to the invention;

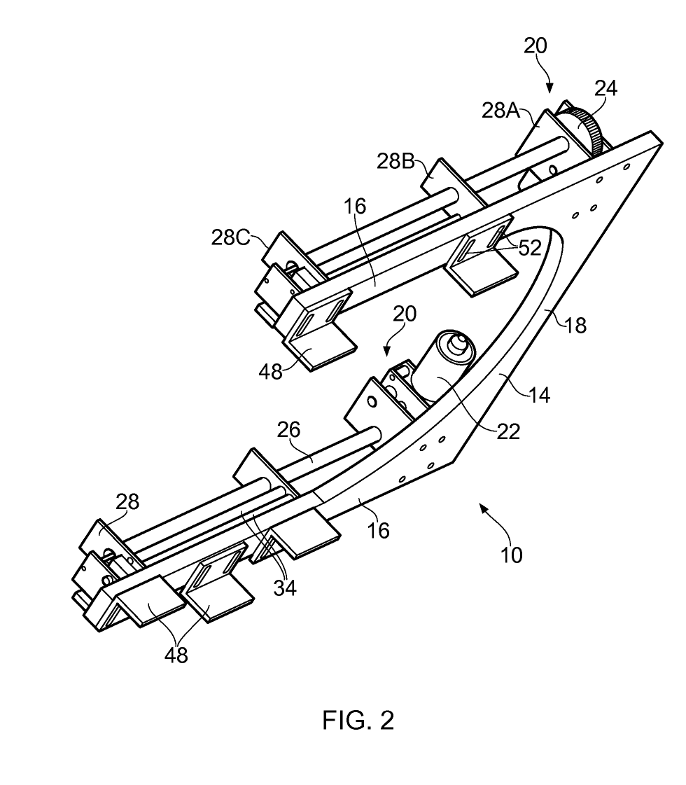

FIG. 2 is a diagrammatic perspective view from beneath of part of the assembly of FIG. 1 in a disassembled condition;

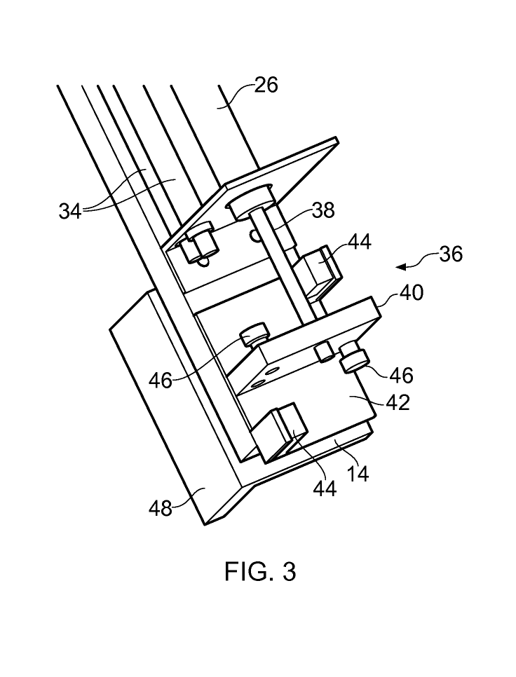

FIG. 3 is a perspective view from above of part of the assembly of FIG. 1;

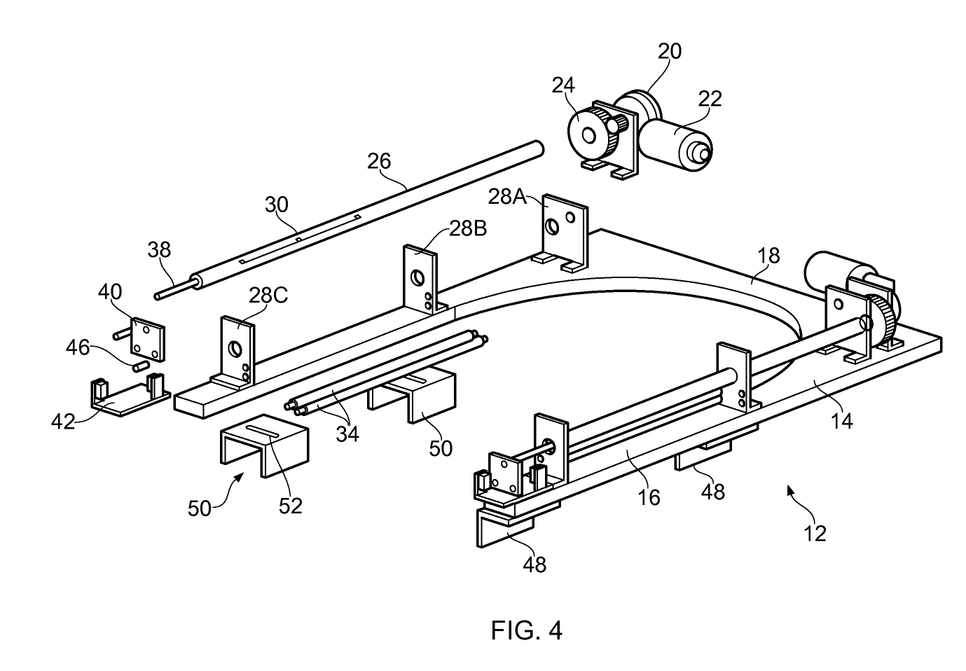

FIG. 4 is a partially exploded perspective view from above of a second bath lift assembly according to the invention in a disassembled condition; and.

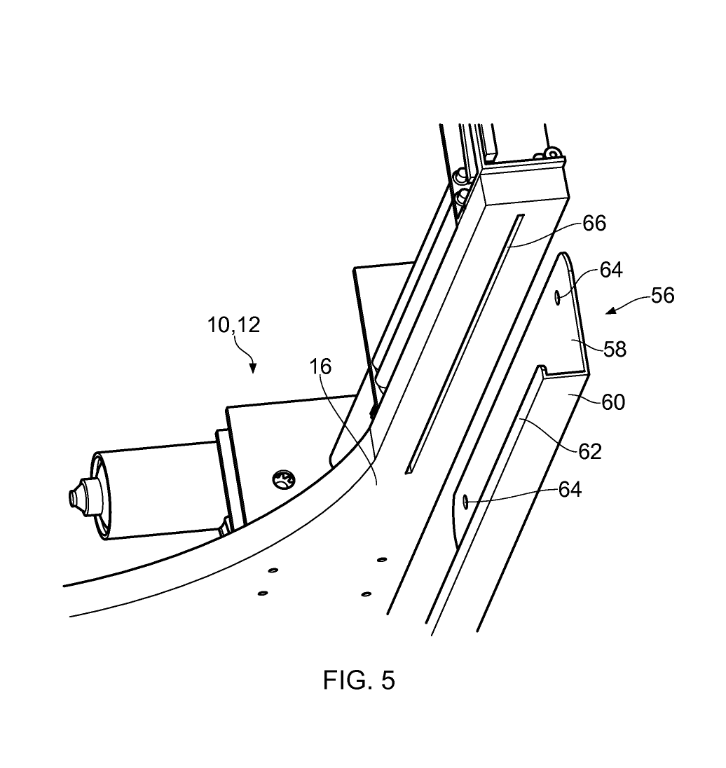

FIG. 5 is diagrammatic perspective view from beneath of part of a bath lift assembly according to the invention.

FIGS. 1 to 3 show a first bath lift assembly 10, whilst FIG. 4 shows a second bath lift assembly 12 which is similar in most respects to the assembly 10, and both assemblies 10, 12 will be simultaneously described to help illustrate the different features of these lifts. Each assembly 10, 12 includes a generally U-shaped frame 14 in the form of a planar member which can locate on top of the end of a bath. The frame 14 has side limbs 16 and a base 18.

A drive arrangement 20 is provided on each corner between the side limbs 16 and the base 18. Each drive arrangement 20 comprises a motor 22 and gear box 24, which drives a respective shaft 26 which extends along the respective side limb 16. Each shaft 26 is supported spaced above the frame 14 by three spaced upstanding support brackets 28. A first support bracket 28A is located adjacent the respective gear box 24. A second bracket 28B is provided spaced therefrom towards a mid part of the side limb 16, with a third bracket 28C located spaced a short distance from the free end of the respective side limb 16.

An elongate fixing hole 30 is provided in the shaft 26 between the brackets 28B and 28C to enable the mounting of an end of a band 32 upon which a person can sit. Spaced below the shaft 26 between the brackets 28B and C are a pair of guide rollers 34, between which the band 32 is extendable.

An automatic stop arrangement 36 is provided at the free end of each shaft 26. The arrangement 36 comprises a threaded bar 38 extending coaxially from the shaft 26. A threaded block 40 is mounted on the bar 38, and is shaped so as to engage against a plate 42 provided on the free end of the respective side limb 16, such that the block 40 cannot rotate, so that rotation of the threaded bar 38 causes longitudinal movement of the block 40.

A pair of micro switches 44 are provided on opposite corners of the plate 42, and a pair of screws 46 are mounted into the block 40 at appropriate positions to be engageable respectively with one of the micro switches 44, such that at one extreme end of movement of the block 40 in one direction one of the screws will engage with a respective micro switch 44 to turn off the motor 22, whilst location of the block 40 in an extreme position in the opposite direction will cause the other screw 46 to engage with the other micro switch 44 to turn off the respective motor 22. Obviously the extent to which the screws 46 extend through the block 40 can be adjusted to adjust the location of the block 40 of which the respective micro switch 44 will be actuated.

A number of mounting brackets are provided on the underside of the frame 14. In the first assembly 10 all of the mounting brackets are in the form of L-shaped brackets 48. Two are provided on a one of the side limbs 16, which side limb would be engageable against a wall adjacent a bath. The brackets 48 are positioned such that a downwardly extending limb will engage against the inside side wall of the bath.

On the other side of the limb 16, three L-shaped brackets 48 are provided with two in a similar orientation to the L-shaped brackets on the first side limb 16, but with the other L-shaped bracket 48 having a downwardly facing limb on the outside edge of the frame 14, to be engageable against the outside wall of a bath.

On the second assembly again two L-shaped brackets 48 are provided on one side limb 16 to be engageable against the inside wall of the bath locatable against a wall of a bathroom. On the other side limb 16 a pair of n-shaped brackets 50 are provided with side limbs engageable on the inside and outside of the bath. The brackets 48, 50 are each mounted to the underside of the frame 14 by one or a pair of slots 52, such that their position relative to the frame 14 can be adjusted to facilitate use with different sized baths. The assemblies 10, 12 can include an appropriate cover such as the cover 54 shown in FIG. 1. This cover 54 will be substantially waterproof, and selectively removable to permit adjustment or maintenance.

The motors 22 can be driven by a DC power supply, and can be controlled by a hand-held controller which would be waterproof and for instance floats, but is not shown in the drawings. The motors 22 would be driven by a rechargeable battery supply, with a rechargeable facility for the batteries away from the bath, and perhaps outside of a bathroom.

In use the respective assembly 10, 12 will be located on an end of a bath, and the position of the brackets 48, 50 can be adjusted if necessary. If required the screws 46 can be adjusted, to provide a required maximum tightness of the band, and/or a required amount of band to be let out before the assembly automatically switches off.

The drive arrangements 20 can then be used to move the band 32 between a raised taut position as shown in FIG. 1, and a loose lowered position with the band 32 engaging on the bottom of the bath. In the raised position a person can sit on the band 32 and swing their legs into or out of the bath. The band 32 can then be fed out by the drive arrangements 20, thereby lowering a user into the bath.

When a person has finished bathing the band 32 can be fed in by the drive arrangements 20, thereby raising the band 32 and hence a person sitting thereon until the taut raised position is reached. It is to be remembered in the raised and lowered position, the stop arrangements 36 will automatically cause the drive arrangements 20 to cease.

In some instances it may be appropriate to have a wall mounted bracket with which the assembly 10, 12 can engage. An example of such a bracket is shown in FIG. 5. Illustrated here is a bracket 56 which is elongate and has a generally L-shaped profile with a stem 58 base 60, and an upturned lip 62 at the end of the base 60.

A pair of mounting holes 64 are provided towards the top corners of the stem 58. In some instances, and particularly for instance with stud walls where the location of the studs may not line up with the mounting holes, a greater number of mounting holes may be provided. A slot 66 is provided in the underside of the base plate 16 which can receive the lip 62. A slot 66 would be provided on the underside of each arm of the base 16 for use with baths with walls on either side thereof.

A wide range of different mounting brackets could be used. For instance one or more projections could be provided on a mounting bracket locatable in correspondingly shaped holes in the underside of the base side limbs.

There are thus described a bath lift assemblies which can readily be located on a bath or removed when not required. The assembly can therefore readily be used on a number of different baths if required. As the band is fed into or out of each side of the assembly this means that a person does not need to slide relative to the band as they are lowered or raised in the bath.

Various other modifications may be made without departing from the scope of the invention. For instance a different drive arrangement could be used, and it may be that a single drive arrangement driving shafts on each side of the assembly may be used, with for instance respective drive chains extending between a single motor and the shafts. The frame could be configured with a base of adjustable length for use with different width baths.

Whilst in the described example the guide rollers are provided below the shafts, the rollers could be provided elsewhere, and could for instance be provided above or in line with the shafts. In the above example the U-shaped frame is in the form of a planar member. The frame could however be made of tubular members, flat plate, as a casting, or otherwise.

A different control arrangement than that described above could be used. In addition to or as an alternative to a hand-held controller, an up/down switch arrangement may be provided on the assembly. Rather than battery power, the assembly may be mains powered via a transformer to alleviate the possibility of electrical shock, with the connection to mains power distant from the assembly.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A bath lift assembly, the assembly including an at least generally U-shaped frame selectively mountable on top of the end of a bath to extend across the end of the bath and part way along the sides of the bath leading therefrom, a roller assembly being provided on each side of the frame with a flexible band upon which a person can sit extending between the assemblies on each side, a drive system being provided to simultaneously operate each roller assembly to selectively feed the band in or out, such that the band is moveable between a raised position with the band taut across the top of the bath, and a lowered position with the band substantially resting on the bottom of the bath.

2. An assembly according to claim 1, characterised in that the drive system comprises a single drive arrangement which operates each roller assembly.

3. An assembly according to claim 2, characterised in that the drive arrangement is connected to each roller assembly by a respective drive chain.

4. An assembly according to claim 1, characterised in that the drive system comprises a separate drive arrangement for each side of the assembly.

5. An assembly according to any of the preceding claims claim 1, characterised in that the drive arrangement or arrangements is arranged to automatically stop when one of the raised or lowered positions is reached.

6. An assembly according to claim 5, characterised in that an adjustable stop arrangement is provided to cause the automatic stopping when the raised or lowered positions are reached.

7. An assembly according to claim 1, characterised in that the apparatus is battery powered.

8. An assembly according to claim 7, characterised in that the batteries are rechargeable.

9. An assembly according to claim 1, characterised in that the apparatus is mains powered via a transformer.

10. An assembly according claim 1, characterised in that a hand-held controller is provided for a user to operate the assembly.

11. An assembly according to claim 1, characterised in that switches are provided on the assembly to operate the assembly.

12. An assembly according to claim 1, characterised in that mounting brackets are provided on the underside of the frame engageable with the bath to retain the assembly in position.

13. An assembly according to claim 12, characterised in that at least some of the mounting brackets are substantially L-shaped.

14. An assembly according to claim 12, characterised in that at least some of the mounting brackets are substantially n-shaped.

15. An assembly according to claim 12, characterised in that the mounting brackets are adjustably mounted on the underside of the frame to be engageable with different sized baths.

16. An assembly according to claim 1, characterised in that a mounting member is provided on at least one side of the assembly, engageable with a wall mountable bracket, to retain a side of the assembly substantially against the wall.

17. An assembly according to claim 1, characterised in that the length of the base of the U of the frame is adjustable to permit use with different width baths.
